(19) United States
(12) Patent Application Publication
(10) Pub. No.: US 2009/0311556 A1
(43) Pub. Date: Dec. 17, 2009

(54) SYNTHESIS, FUNCTIONALIZATION AND ASSEMBLY OF MONODISPERSE HIGH-COERCIVITY SILICA-CAPPED FePt NANOMAGNETS OF TUNABLE SIZE, COMPOSITION AND THERMAL STABILITY FROM IMCROEMULSIONS

(75) Inventors: Ramanath Ganapathiraman, Clifton Park, NY (US); Qingyu Yan, Troy, NY (US); Arup Purkayastha, Bangalore (IN)

Correspondence Address: FOLEY AND LARDNER LLP;SUITE 500, 3000 K STREET NW, WASHINGTON, DC, 20007, US

(73) Assignee: Rensselaer Polytechnic Institute

(21) Appl. No.: 12/297,372

(22) PCT Filed: Apr. 13, 2007
(86) PCT No.: PCT/US07/09045

§ 371 Date: Feb. 27, 2009

Related U.S. Application Data
(60) Provisional application No. 60/792,494, filed on Apr. 17, 2006.

(51) Int. Cl. G11B 5/33

(52) U.S. Cl. 428/800; 977/773

(57) ABSTRACT

A nanoparticle includes a metal core and an outer shell. The metal core includes a magnetic alloy of platinum and at least one additional metal. The outer shell is selected from the group consisting of silica, titania, metal nitride, and metal sulfide.

### CROSS-REFERENCE TO RELATED PATENT APPLICATIONS

This application claims priority to U.S. Provisional Application Ser. No. 60/792,494, filed on Apr. 17, 2006, which is incorporated herein by reference in its entirety.

### STATEMENT REGARDING FEDERALLY-SPONSORED RESEARCH OR DEVELOPMENT

This invention was made with Government support under grant number DMR 0519081 awarded by the National Science Foundation. The Government has certain rights in the invention.

### BACKGROUND OF THE INVENTION

The present invention relates generally to the field of nanoparticles and specifically to magnetic nanoparticles with tunable size, composition and thermal stability.

The use of magnetic nanoparticles as individual data bits in ultra-high density recording media is a challenge because of the increased influence of thermally-induced spin randomization (superparamagnetism) in decreased magnetic bit volumes. Control over particle size and dispersity is desired when forming ordered arrays of nanoparticles. Using each of the magnetic nanoparticles as individual data bits also requires the formation of ordered nanoparticle assemblies that do not agglomerate during high-temperature annealing (e.g., 550 degrees Celsius) treatments used to obtain the high magnetocrystalline anisotropic, face-centered tetragonal (fct) L1₀ phase.

An article by Kumbhar et al., entitled “Magnetic properties of cobalt and cobalt-platinum alloy nanoparticles synthesized via microemulsion technique”, IEEE Transactions on Magnetics, Vol. 37, Issue 4 (2001) 2216-2218, which is incorporated herein by reference in its entirety, describes a reverse micelle process for making CoPt nanoparticles from microemulsions stabilized with ionic cetyltrimethyl bromide (CTAB) surfactant. The resultant CoPt nanoparticles were relatively large (e.g., >15 nm), with high dispersity (>30%), high assembly disorder, and low room temperature coercivity (H_{c}≈50 mT).

An article by Liu et al., entitled “Reduction of sintering during annealing of FePt nanoparticles coated with iron oxide”, Chemistry of Materials, Vol. 17, No. 3 (2005) 620-625, which is incorporated herein by reference in its entirety, describes FePt/Fe₃O₄ core/shell nanoparticles formed by a two-step polyol process with 1,2-hexadecanediol as the reducing reagent. These FePt/Fe₃O₄ core/shell nanoparticles are stable after annealing at 550 degrees Celsius for 30 minutes, whereas FePt nanoparticles without oxide shell coatings start to sinter at those conditions. However, the Fe₃O₄ shell degrades at temperatures less than about 600 degrees Celsius, which destroys the nanoparticle size and shape.

### SUMMARY OF THE INVENTION

A nanoparticle includes a metal core and an outer shell. The metal core includes a magnetic alloy of platinum and at least one additional metal. The outer shell is selected from the group consisting of silica, titania, metal nitride, and metal sulfide.

### BRIEF DESCRIPTION OF THE DRAWINGS

FIG. 1 is a schematic representation of steps in a method of making nanoparticles according to an embodiment of the invention.

FIGS. 2A-2C are transmission electron microscopy (TEM) images of octadecanethiol-capped FePt nanoparticles according to an embodiment of the invention.

FIG. 2D is a plot of measured size distributions of and water droplets and the nanoparticles shown in FIGS. 2A-2C.

FIG. 3 is a plot of measured nanodroplet size determined from dynamic light scattering, measured nanoparticle size obtained from TEM data, and calculated nanoparticle size, versus water-to-surfactant ratio.

FIGS. 4A-4B are plots of measured X-ray diffraction intensity versus angle for octadecanethiol-capped FePt nanoparticles prepared from microemulsions according to an embodiment of the invention.

FIG. 4C is a plot of measured coercivity versus annealing temperature for different diameter FePt nanoparticles according to an embodiment of the invention.

FIG. 4D is a TEM image of FePt nanoparticles according to an embodiment of the invention.

FIGS. 5A-5D are TEM images of FePt/silica core/shell nanoparticles according to an embodiment of the invention.

FIGS. 6A-6B are TEM images of FePt/silica core/shell nanoparticles capped (functionalized) with methoxy(dimethyl)octylsilane according to an embodiment of the invention.

FIG. 6C is a plot of measured size distributions of the nanoparticles in FIGS. 6A-6B.

FIG. 7A is a plot of measured X-ray diffraction intensity versus angle for FePt/silica core/shell nanoparticles capped with methoxy(dimethyl)octylsilane according to an embodiment of the invention.

FIG. 7B is a plot of measured room-temperature hysteresis loops for the nanoparticles in FIG. 7A.

### DETAILED DESCRIPTION OF THE PREFERRED EMBODIMENTS

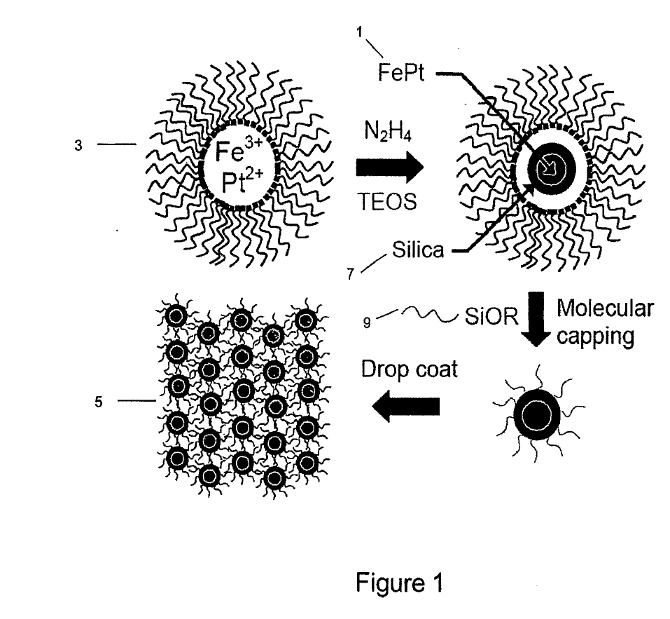

FIG. 1 illustrates the steps in a method of making nanoparticles with control over composition, particle size and dispersity, according to one embodiment of the invention. FePt nanoparticles 1 were made by the following method. Aqueous metal salts of Pt and Fe were mixed with a non-ionic surfactant in a non-polar solvent, iso-octane to obtain a reverse micellar microemulsion 3 in the form of aqueous nanodroplets. The relative inertness and high solubility of non-ionic surfactants compared with ionic surfactants provide a larger and more tunable range of narrow dispersity water nanodroplets that can be used for nanoparticle synthesis. The surfactant used to stabilize the water nanodroplets was either polyoxyethylene-2-cetyl ether [C₁₆H₃₃(OCH₂CH₂)₂OH (brij® 52)] or polyoxyethylene-10-cetyl ether [C₁₆H₃₃(OCH₂CH₂)₁₀OH (brij® 56)]. A reducing agent, hydrazine, was added to the microemulsion 3 to simultaneously reduce the metal salts in the nanodroplets to form FePt nanoparticles 1. In a typical synthesis, 0.012-0.050 mole brij® 56 or brij® 52 was added to 40 mL iso-octane, and dissolved by sonicating the mixture for 15 minutes at 30 degrees Celsius. In separate beakers, 0.30 mM potassium tetrachloroplatinate (K₂PtCl₄) and 0.30-0.50 mM ferric chloride (FeCl₃) were added to 0.032-0.066 M de-ionized water. The two microemulsions were mixed with each other and sonicated for 30 minutes. Small amounts (1-5 mM) of butanol were used as a co-surfactant to improve particle shape. Upon adding 0.8 mL hydrazine (N₂H₄ anhydrate) to the magnetically stirred microemulsion maintained at 30 degrees Celsius, the initially transparent yellow solution turns into a dark dispersion. After 3 hours, 0.5 mM octadecanethiol was added to the microemulsion and aged for 10 minutes. The octadecanethiol renders the FePt nanoparticles 1 dispersible in non-polar solvents and to facilitate an ordered assembly 5 of nanoparticles by drop coating. Optionally, the octadecanethiol is omitted. The nanoparticles 1 were precipitated by adding isopropanol, and were isolated by repeated redispersion in hexane, precipitation in ethanol, and centrifuging. The nanoparticles 1 were dried at room temperature in air. The water-to-surfactant ratio (W₀) was varied to control the size of the nanoparticles 1. The chemical composition of the nanoparticles was controlled by adjusting the molar ratio of K₂PtCl₄ and FeCl₃ in the microemulsion 3.

The method of making FePt nanoparticles 1 can be varied. For example, the platinum precursor may include other platinum-containing salts, such as PtCl₄. The iron precursor may include other iron-containing salts, such as FeCl₂, Fe(NO₃)₂ and Fe(NO₃)₃. Various other types of non-ionic surfactants can also be used, such as polyethylene-glycol-dodecyl ether (brij®30), polyoxyethylene-23-lauryl ether (brij®35), polyethylene-glycol-hexadecyl ether (brij®58), polyoxyethylene-10-stearyl ether (brij®76), polyethylene-glycol-octadecyl ether (brij®78), polyoxylethylene-2-oleyl ether (brij®92, brij®97), polyoxyethylene-20-oleyl ether (brij®98), polyoxyethylene-5-isooctylphenyl ether (NP-5), tetraethylene-glycol-monododecyl ether (C₁₂E₄), n-dodecyl octaoxyethylene-glycol ether (C₁₂E₈). The non-polar solvent may include cyclo-hexane, toluene, and octane.

The method of making FePt nanoparticles 1 can be used to make nanoparticles containing other types of metals, such as cobalt, which can form magnetic alloy nanoparticles. For example, the magnetic precursor can be an aqueous metal salt of cobalt, such as CoCl₂ or Co(NO₃)₂, which is then reduced with a platinum precursor in a microemulsion to form a CoPt nanoparticle. Optionally, the nanoparticles can include more than one magnetic metal. For example, microemulsions containing precursors of iron, cobalt, and platinum may result in FeₓCo_{y}Pt_{1-x-y} nanoparticles, where x and y are molar percentages of iron and cobalt, respectively.

As illustrated in FIG. 1, the FePt nanoparticles 1 may also include an outer shell, such as an insulating shell, for example, a silica shell 7. Preferably, the silica shell 7 is formed in the same microemulsion 3 in which the FePt nanoparticle 1 is formed. After 3 hours following the reduction reaction of the FePt nanoparticles 1, 0.2-1 mM of tetraethoxysilane (TEOS) was injected into the microemulsion using a micro-syringe. No octadecanethiol was used during the formation of FePt/silica core/shell nanoparticles. However, octadecanethiol may optionally be used. The mixture was aged for 3 hours to form the silica shell 7 by hydrolysis and condensation of TEOS. The thickness of the silica shell 7 was controlled by varying the molar ratio of TEOS to FePt in the range of about 1 to about 5. Preferably, the outer shell is thin, with a thickness less than about 5 nm, such as about 1 nm to about 4 nm. The outer shell can also be made of other materials besides silica. For example, titania shells can be made by providing organo-titanium compounds into the microemulsion. Alternatively, shells made of a nitride or a sulfide can be made by flowing in appropriate gases, such as ammonia or hydrogen sulfide, into the microemulsion.

FIG. 1 also shows the step of functionalization comprising attaching an organic capping agent 9 to the outer surface of the silica shells 7. The FePt/silica core/shell nanoparticles were centrifuged out and redispersed into isopropanol. The capping agent 9 (1 mM of methoxy(dimethyl)octylsilane) was added to the solution. The solution was then heated to 60 degrees Celsius for one hour to promote the attachment of methoxy(dimethyl)octylsilane onto the surface of the silica shells 7. Dispersions of the nanoparticles in toluene were drop-coated onto silicon oxide-coated 200 mesh Cu grids for TEM measurements. The capping agent 9 renders the nanoparticles dispersible in non-polar solvents (e.g. octane, toluene), and facilitates the formation of an ordered assembly 5 by inhibiting nanoparticle clustering. Preferably, the ordered assembly 5 is monodisperse. Other types of capping agents 9 may also be used, such as organosilanes (e.g., dimethyl-alkoxy silanes) having such functional groups as carboxylic acid and amine functional groups.

For materials microanalysis, a Philips CM 12 and CM 20 TEMs were used to characterize the particle size and microstructure. The particle composition was determined by energy dispersive X-ray (EDX) analysis in the Philips CM 12 TEM. The sample compositions were obtained by using the Evex Nanoanalysis program which includes ZAF corrections. The size of the water droplets in the microemulsion was determined by dynamic light scattering in a BI-200SM/BI-9010AT Brookhaven Instruments system. Nanoparticle films of about 100 nm to about 150 nm thicknesses were obtained by drop-coating the toluene solution containing the as-prepared nanoparticles onto a 1 cm×1 cm Si(001) wafer piece for X-ray diffraction and vibrating sample magnetometry (VSM). The solvent was allowed to evaporate slowly at room temperature in air. The nanoparticle thin films and TEM samples were annealed in a 4×10⁻⁶ Torr vacuum at preselected temperatures between 500 and 650 degrees Celsius for 30-60 minutes. The constituent phases were determined by X-ray diffraction using a SCINTAG/PAD-V diffractometer using Cu Kα radiation. Magnetic properties were characterized at room temperature, in a Lake Shore 7400 VSM instrument using applied magnetic fields up to 2 T. The hysteresis loops were measured with the applied magnetic field parallel (in plane) to the nanoparticle film surface.

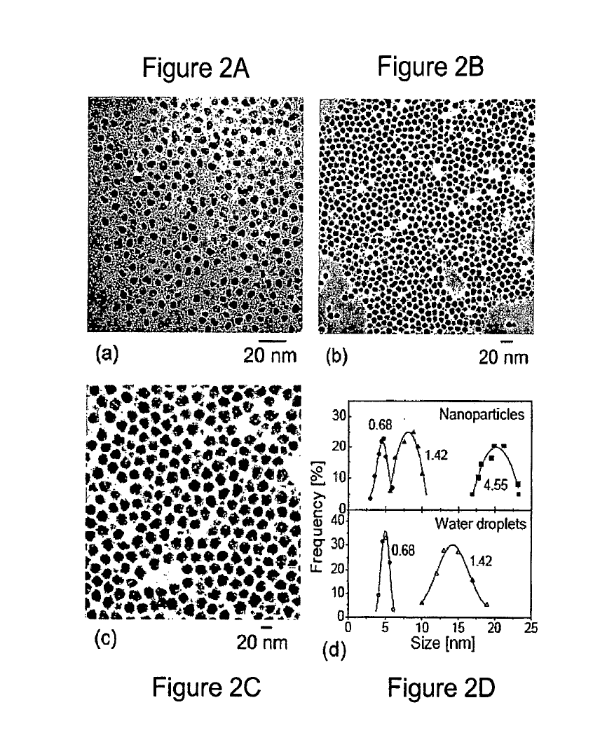

FIGS. 2A-2C show TEM images of octadecanethiol-capped FePt nanoparticles synthesized in microemulsions with different water-to-surfactant ratios: (A) 0.68, (B) 1.42, and (C) 4.55. Octadecanethiol capping facilitates ordered assembly by inhibiting nanoparticle clustering at room temperature. The particle size can be controlled by adjusting the water-to-surfactant molar ratio W₀. The average size of the FePt nanoparticles can be controlled from about 4 nm to about 21 nm, such as from about 4.5 nm when W₀=0.68 (shown in FIG. 2A) to about 8.5 nm when W₀=1.42 to about 20.2 nm when W₀=4.55 (shown in FIG. 2C). FIG. 2D shows that the standard deviation of the nanoparticle sizes in the images of FIGS. 2A-2C is remarkably low, in the range of approximately 8% to 11%, with Gaussian fits shown as solid lines in FIG. 2D. The inter-particle spacing of 4 nm is attributed to octadecanethiol capping.

Energy dispersive X-ray (EDX) spectroscopy reveals that the molar ratio of iron to platinum in the FePt nanoparticles can be easily adjusted by the initial molar ratio of the precursors Fe(Cl)₃/K₂Pt(Cl)₄ used in the microemulsion. Table 1 shows that the fractional difference (Δ=(x₁/y₁−x₂/y₂)/(x₁/y₁)) between the precursor and nanoparticle molar ratios is less than about 4%, such as about 3% for nanoparticles with a size of 20.2 nm. The accurate control of nanoparticle composition is attributed to the use of non-ionic surfactants, which allows the metal ion concentration within the droplets to remain the same as in the bulk solutions.

TABLE 1
Correlation between precursor ratio and FePt composition

| Nanoparticle | FeCl3 | K2PtCl4 | Nanoparticle | δ |
|---|---|---|---|---|
| size [nm] | [x₁ mM] | [y₁ mM] | Feₓ₂Pt_{y2} | [%] |
| 20.2 | 0.322 | 0.30 | Fe₅₁Pt₄₉ | 3.0 |
| 8.5 | 0.361 | 0.30 | Fe₅₅Pt₄5 | 2.4 |
| 4.5 | 0.501 | 0.30 | Fe₆₃Pt₃₇ | 1.9 |

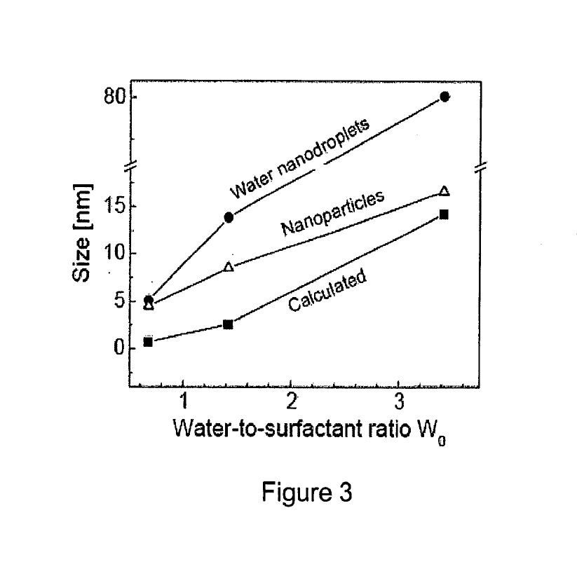

FIG. 3 shows that the nanoparticle sizes measured using TEM correlate well with the mean water nanodroplet sizes determined from dynamic light scattering for microemulsions with corresponding W₀ used for nanoparticle synthesis. This result suggests that water nanodroplets, whose size is controlled by W₀, serve as nanoreactors for the metal salts reduction reactions, and thereby determine the nanoparticle size. Nanoparticle sizes calculated from nanodroplet sizes (assuming mass balance and bulk density) are, however, lower than the measured values, suggesting dynamic phenomena such as droplet collision, coalescence, and content sharing leading to multicrystalline nanoparticles.

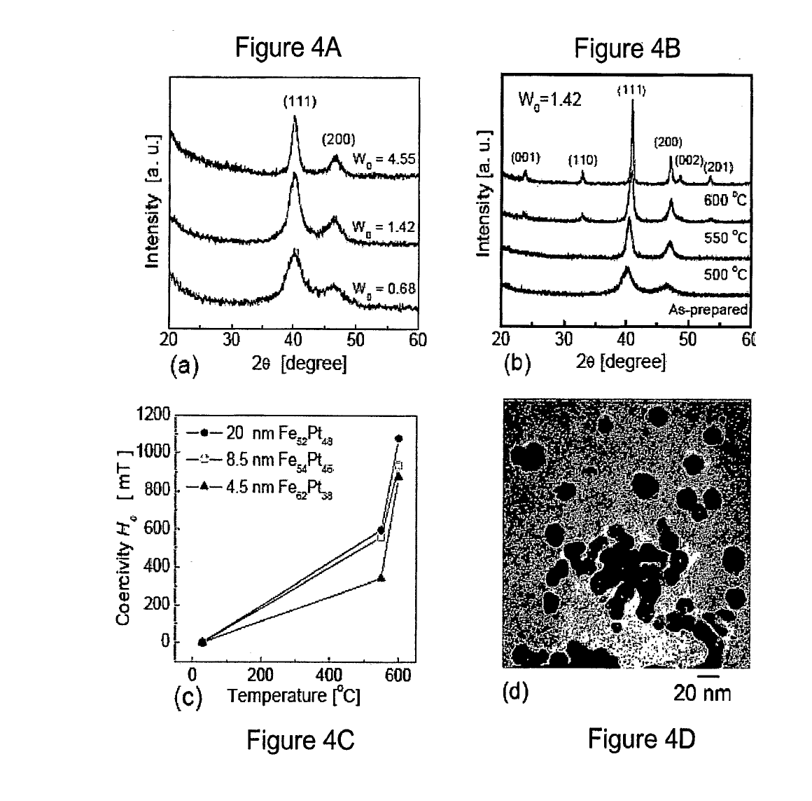

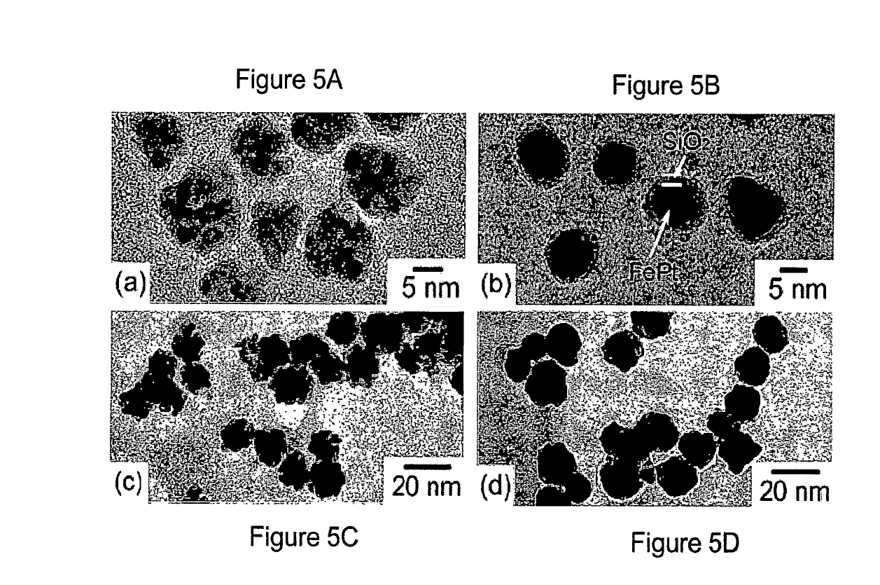

FIGS. 4A and 4B show X-ray diffractograms obtained from as-prepared FePt nanoparticles before and after vacuum annealing, respectively. The spectra in FIG. 4A reveal Bragg reflections corresponding to disordered face-centered-cubic FePt for all three particle sizes, with narrower Bragg peaks for larger particles. No Bragg peaks corresponding to iron oxides are observable in any of the diffractograms even though the synthesis process was not performed in an inert environment, for example the synthesis process was not performed in an argon or nitrogen glove box. Crystalline domain sizes estimated from the peak widths are 3.6 nm, 5.0 nm, and 8.4 nm for W₀=0.68, 0.55, and 4.55, respectively. The domain sizes are approximately 20-60% smaller than the particle sizes determined using TEM, corroborating smaller crystal domains within nanoparticles. High-resolution TEM measurements, which will be described in greater detail with regard to FIGS. 5A-5D, confirm that each nanoparticle consists of a cluster of smaller crystals. FIG. 4B shows a diffractogram for a 8.5 nm FePt particle (W₀=1.42) as the face-centered cubic phase is transformed to the face-centered tetragonal phase, as evidenced by the appearance of (001) (110) and (201) reflections, after vacuum annealing for 30 minutes at different temperatures to 500, 550 and 600 degrees Celsius.

FIG. 4C shows an increase in coercivity (H_{c}) with increasing annealing temperatures for all three particle sizes. The as-prepared nanoparticles are superparamagnetic with a room-temperature coercivity H_{c} less than about 3 mT for FePt particles of all three sizes. Vacuum annealing was performed for 30 minutes. For all three sizes, annealing at 600° C. for 30 minutes increases H_{c} to greater than about 800 mT, such as about 850 to about 1100 mT, as measured at room temperature.

FIG. 4D shows a TEM image of 8.5 nm-sized as-prepared octadecanethiol-capped FePt nanoparticles following an annealing step at 500 degrees Celsius for 30 minutes. The octadecanethiol-capped FePt nanoparticles exhibit substantial coalescence at temperatures greater than about 500 degrees Celsius, which makes it difficult to determine the contributions of chemical ordering or particle coalescence to the H_{c} increase. Moreover, nanoparticle coalescence is undesirable because it destabilizes the assembly and negates the advantages of using nanoparticles in ultrahigh density information storage devices. Replacing the octadecanethiol capping agent with oleic acid in the synthesis does not lead to any noticeable improvement in coalescence characteristics.

FIGS. 5A-5D show TEM images of FePt/silica core/shell nanoparticles. The nanoparticles in FIGS. 5A-5D were prepared using a K₂PtCl₄/TEOS ratio equal to 1 and have a FePt metal core with an average size of 8.5 nm and a silica shell with a thickness of about 2 nm. As seen in FIG. 5A, prior to annealing, each core/shell nanoparticle contains multiple regions of strongly diffracting crystalline domains (seen as dark regions), which are enveloped by an amorphous silica shell (seen as light-gray regions). This result suggests multiple nucleation events within each water nanodroplet. As seen in FIG. 5B, the multiple crystals merge to form a unified FePt core upon annealing at 600 degrees Celsius for 60 minutes, but there are no observable changes in the overall size and shape of the FePt/silica core/shell nanoparticles. The core and the shell are indicated by arrows in FIG. 5B. The average size of the FePt core is about 7 nm to about 10 nm, such as 8.5 nm. The average thickness of the silica shell is about 1 nm to about 3 nm, such as 2 nm. However, shell thicknesses up to 100 nm may be obtained by growing the shell for longer periods at optimized TEOS concentrations.

As seen in both of the larger-scale images of FIGS. 5C-5D, the FePt/silica core/shell nanoparticles tend to cluster into disordered nanoparticle aggregates when deposited from polar solvents (e.g., water, isopropyl alcohol) onto a surface. This is likely due to strong hydrogen bonding between nanoparticles, which causes clustering even at room temperature prior to annealing, as shown in FIG. 5C. FIG. 5D shows that after annealing at 600 degrees Celsius for 60 minutes, the FePt/silica core/shell nanoparticles exhibit substantially no coalescence, unlike the FePt nanoparticles in FIG. 4D. This result suggests that the silica shell inhibits coalescence during the annealing step. However, the observed clustering in FIGS. 5C-5D is undesirable because ordered nanoparticles arrays are preferred for use in ultrahigh-density information storage applications.

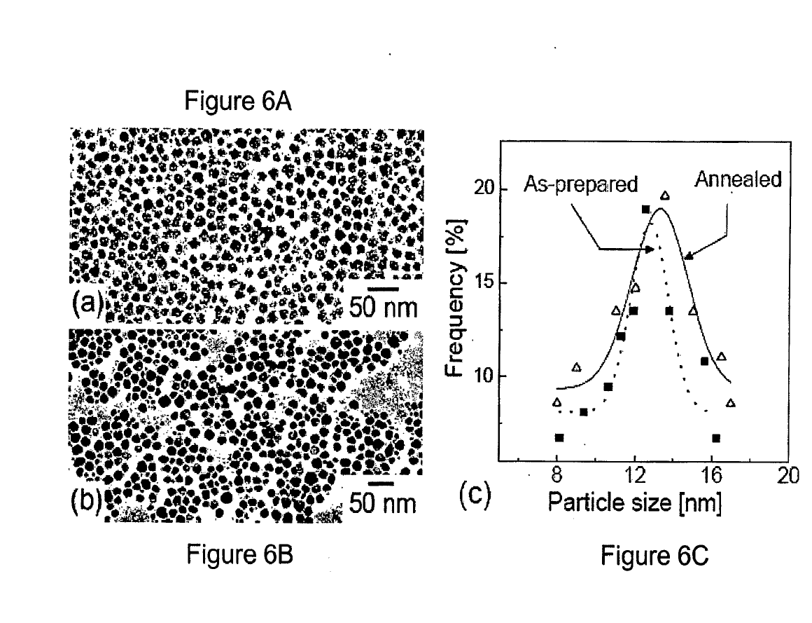

FIGS. 6A-6B show TEM images of an ordered assembly of FePt/silica core/shell nanoparticles capped with methoxy(dimethyl)octylsilane, before and after annealing at 650 degrees Celsius for 60 minutes, respectively. FIG. 6A shows that these organosilane-functionalized nanoparticles exhibit substantially no clustering at room temperature, unlike the nanoparticles in FIG. 5C. This result suggests that the organic capping agent inhibits clustering by reducing the attractive forces between adjacent nanoparticles. FIG. 6B shows that no noticeable size changes or coalescence are observed upon annealing at these conditions. However, the positional order of the nanoparticles is disrupted, presumably due to organosilane decomposition. Nevertheless, the inhibited clustering of the organosilane-functionalized FePt/silica core/shell nanoparticles in FIG. 6B is a marked improvement over the observed clustering of the nonfunctionalized FePt/silica core/shell nanoparticles in FIG. 5D, which were subjected to an identical annealing treatment at 650 degrees Celsius for 60 minutes. In addition to suppressing clustering, the organic capping agent can be used to integrate the nanoparticles into molecularly engineered surfaces and matrices. For example, the functionalized nanoparticles can be used as fillers in magnetocomposites or as thin films in flexible memory devices.

FIG. 6C shows the size distribution of methoxy(dimethyl)octylsilane functionalized FePt/silica core/shell nanoparticles determined from FIGS. 6A-6B. Gaussian fits are shown as solid and dotted lines. These results confirm that the silica shell helps to inhibit coalescence and helps retain the particles' size and shape.

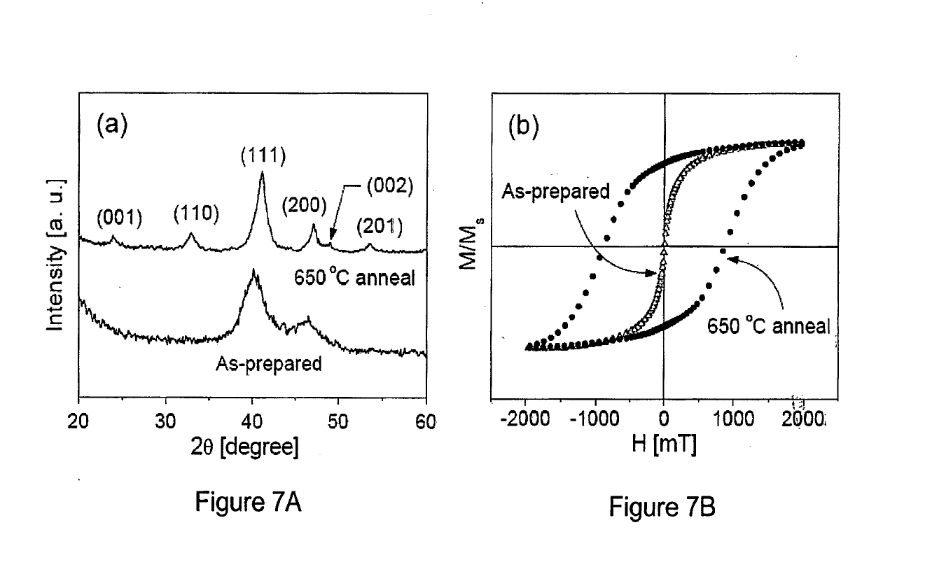

FIGS. 7A-7B show that the methoxy(dimethyl)octylsilane functionalized FePt/silica core/shell nanoparticles become substantially ferromagnetic upon annealing at 650 degrees Celsius for 30 minutes. FIG. 7A shows that the FePt cores transform to the fct L1₀ structure, as indicated by the emergence of (001), (110) and (201) Bragg peaks, and an ordering parameter S=0.796 determined from the intensity ratio between (110) and (111) peaks. FIG. 7B shows that the coercivity H_{c} of these nanoparticles increases to about 850 mT. Without wishing to be bound to any particular theory, the inventors believe that this high coercivity is attributed to L1₀ ordering because nanoparticle coalescence is suppressed. Thus, the silica shells allow the formation of a unified FePt core and L1₀ ordering within each nanoparticle, but prevent the coalescence of the FePt cores of adjacent core-shell nanoparticles in the assembly. The high H_{c}, high thermal stability, and amenability to functionalization and assembly, are attractive attributes of the silica-shelled FePt nanoparticles, which can be exploited for integrating the nanoparticles with molecularly tailored surfaces and matrices for data storage, such as thin film recording media applications.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. A nanoparticle comprising a metal core and an outer shell, wherein:
the metal core comprises a magnetic alloy of platinum and at least one additional metal; and
the outer shell is selected from the group consisting of silica, titania, metal nitride, or metal sulfide.

2. The nanoparticle of claim 1, wherein the additional metal is selected from the group consisting of iron and cobalt.

3. The nanoparticle of claim 2, wherein:
the additional metal comprises iron;
the outer shell comprises silica; and
an average size of the metal core is about 4 nm to about 21 nm.

4. The nanoparticle of claim 3, wherein:
the average size of the metal core is about 7 nm to about 10 nm; and
an average thickness of the outer shell is about 1 nm to about 100 nm.

5. The nanoparticle of claim 3, wherein the metal core comprises an ordered face-centered tetragonal L1₀ crystal structure.

6. The nanoparticle of claim 5, wherein the nanoparticle has a coercivity of at least about 800 mT and the nanoparticle is adapted to substantially retain its size and shape after 30 minutes of annealing at a temperature of about 600 degrees Celsius.

7. The nanoparticle of claim 6, wherein the nanoparticle comprises a data bit in a magnetic storage device.

8. The nanoparticle of claim 1, further comprising an organic capping agent attached to the outer shell.

9. The nanoparticle of claim 8, wherein the nanoparticle is bound to a solid surface or imbedded in a solid matrix.

10. The nanoparticle of claim 8, wherein the organic capping agent comprises organosilane.

11. The nanoparticle of claim 10, wherein the organosilane is selected from the group consisting of methoxy(dimethyl)octylsilane, an organosilane comprising an amine functional group, and an organosilane comprising a carboxylic acid functional group.

12. A plurality of nanoparticles, wherein:
each nanoparticle in the plurality of nanoparticles comprises an outer shell and a metal core comprising a magnetic alloy of platinum and at least one additional metal;
the nanoparticles are adapted to exhibit substantially no coalescence upon 30 minutes of annealing at a temperature equal to about 600 degrees Celsius; and
the outer shell comprises an average thickness less than about 5 nm.

13. The plurality of claim 12, wherein the metal core comprises an average size of about 4 nm to about 21 nm having a sample standard deviation of about 8% to about 11%.

14. The plurality of claim 12, wherein:
the metal cores of the nanoparticles are made by a process comprising:
providing a microemulsion comprising a platinum precursor and a precursor of the at least one additional metal; and
reducing the precursors to form the metal cores;
the microemulsion comprises an initial molar ratio of the platinum precursor to the precursor of the at least one additional metal; and
the metal core comprises an average molar ratio of platinum to the at least one additional metal that is within at least about 4% of the initial molar ratio.

15. The plurality of claim 12, further comprising an organic capping agent attached to the outer shells, wherein the nanoparticles are adapted to exhibit substantially no clustering at about room temperature.

16. The plurality of claim 15, wherein the nanoparticles are bound to a solid surface or imbedded in a solid matrix.

17. The plurality of claim 15, wherein the nanoparticles comprise a monodisperse film on a solid surface.

18. The plurality of claim 12, wherein:
the additional metal is iron;
the outer shell is silica; and
the metal core comprises a face-centered tetragonal crystal structure.

19. The plurality of claim 18, wherein the nanoparticles have a coercivity of at least 800 mT.

20. A magnetic storage device comprising the plurality of claim 12.

21.-35. (canceled)

36. A plurality of magnetic FePt or CoPt nanoparticles having a coercivity of at least 800 mT and the nanoparticles exhibit substantially no coalescence or agglomeration.

37. The nanoparticles of claim 36, wherein each nanoparticle of the plurality of nanoparticles further comprises a silica or titania shell.

38. The nanoparticles of claim 36, wherein each nonparticle comprises a metal core and an outer shell, wherein:
the metal core comprises an alloy of platinum and at least one of iron and cobalt; and
the outer shell is selected from the group consisting of silica, titania, metal nitride, or metal sulfide.
